(19) United States
(12) Patent Application Publication
(10) Pub. No.: US 2016/0098791 A1
(43) Pub. Date: Apr. 7, 2016

(54) METHOD, TERMINAL AND SYSTEM FOR RESETTING PAYMENT PASSWORD

(71) Applicant: Tencent Technology (Shenzhen) Company Limited, Shenzhen (CN)

(72) Inventor: Canhui HUANG, Shenzhen (CN)

(21) Appl. No.: 14/970,200

(22) Filed: Dec. 15, 2015

Related U.S. Application Data
(63) Continuation of application No. PCT/CN2014/086253, filed on Sep. 11, 2014.

(30) Foreign Application Priority Data
Dec. 24, 2013 (CN) 201310723546.5

(51) Int. Cl. G06Q 40/02

(52) U.S. Cl. CPC G06Q 40/02

(57) ABSTRACT

A method for resetting a payment password is disclosed. The method includes: at a payment server, receiving, from a portable electronic device, a payment card password reset request corresponding to a first payment card associated with a first user account and determining if the payment server has authority to reset the payment card password for the first payment card. The method further includes, in accordance with a determination that the payment server lacks the authority to reset the payment card password for the first payment card, instructing the portable electronic device to retrieve, in lieu of password reset information for the first payment card, card information corresponding to a first alternate payment card; receiving, from the portable electronic device, a response including card information corresponding to the first alternate payment card; and determining validity of the card information corresponding to the first alternate payment card.

### PRIORITY CLAIM AND RELATED APPLICATIONS

This application is a continuation application of PCT Patent Application No. PCT/CN2014/086253, entitled “Method, Terminal and System for Resetting Payment Password” filed on Sep. 11, 2014, which claims priority to Chinese Patent Application No. 201310723546.5, “Method, Terminal, and System for Resetting Payment Password,” filed on Dec. 24, 2013, both of which are hereby incorporated by reference in their entirety.

### FIELD OF THE INVENTION

The present application relates to Internet technology, and particularly relates to an Internet-based payment password reset method, terminal and system.

### BACKGROUND OF THE INVENTION

Along with the rapid development of Internet technology, electronic payment has become a payment mode widely applied in people's daily life, and owing to providing various payment means and reliable service guarantee, the third party electronic payment platform becomes one of payment modes widely applied in electronic payment.

When a user performs rapid payment based on a client via a third party electronic payment platform, the client requires the user to input a corresponding payment password, and sends the payment password input by the user to a server; and after the payment password input by the user passes the verification of the server, the server executes a corresponding payment operation. At present, an international payment bank card or an international credit card (subsequently “international card” for short) can be used by a user without the need of binding identification information, such as the user ID card number and the like, for uniquely confirming the user's identity at the time of use by the user. Thus, when a client terminal, according to a payment operation event triggered by the user on a third party payment platform, performs a payment operation using the international card, if the server determines that the payment password submitted for the international card is wrong, the client will be unable to use the payment account corresponding to the international card to perform electronic payment, and has to re-register a corresponding payment account. This process is inconvenient and time consuming for the user, and disrupts the user's payment experience.

### SUMMARY

The above deficiencies and other problems associated with payment password resetting are addressed by the techniques disclosed herein. In some embodiments, the method for resetting payment password is implemented on a computer system that has one or more processors, memory and one or more modules, programs or sets of instructions stored in the memory for performing multiple functions. Instructions for performing these functions may be included in a computer program product configured for execution by one or more processors.

In one aspect, a computer-implemented method of resetting a payment password includes: at a payment server having one or more processors, and memory for storing programs to be executed by the one or more processors, receiving, from a portable electronic device, a payment card password reset request corresponding to a first payment card associated with a first user account and determining if the payment server has authority to reset the payment card password for the first payment card. The method further includes, in accordance with a determination that the payment server lacks the authority to reset the payment card password for the first payment card, instructing the portable electronic device to retrieve, in lieu of password reset information for the first payment card, card information corresponding to a first alternate payment card, receiving, from the portable electronic device, a response comprising card information corresponding to the first alternate payment card and determining validity of the card information corresponding to the first alternate payment card.

In another aspect, a server for performing the password resetting includes memory, one or more processors, and one or more programs stored in the memory and configured for execution by the one or more processors to perform the method described herein.

In another aspect, a non-transitory computer readable storage medium stores one or more programs, the one or more programs comprising instructions, which when executed by a server, cause the server to perform the method described herein.

Various advantages of the present application would be apparent in light of the descriptions below.

### BRIEF DESCRIPTION OF THE DRAWINGS

The aforementioned features and advantages of the invention as well as additional features and advantages thereof will be more clearly understood hereinafter as a result of a detailed description of preferred embodiments when taken in conjunction with the drawings.

FIG. 1 is a flowchart of a payment password reset method in accordance with some embodiments;

FIG. 2 illustrates an exemplary user interface presented at a time when an incorrect payment password has been provided before the method for resetting the payment password is triggered, in accordance with some embodiments;

FIG. 3 illustrates an exemplary user interface presented during resetting of a payment password in accordance with some embodiments;

FIG. 4 is a flowchart of a payment password reset method in accordance with some embodiments, in which a terminal responds to a payment password reset instruction and receives a second bank card added by a user and a new payment password;

FIG. 5 illustrates an exemplary international card operation interface corresponding to a payment account in a payment password reset method in accordance with some embodiments;

FIG. 6 illustrates an exemplary user interface for adding an international card for a payment account in a payment password reset method in accordance with some embodiments;

FIG. 7 is a block diagram of functional modules of a payment password reset terminal in accordance with some embodiments;

FIG. 8 is a block diagram of a hardware structure of a payment password reset terminal in accordance with some embodiments;

FIG. 9 illustrates the process flow of a payment password reset method in accordance with some embodiments;

FIG. 10 illustrates the process flow of a payment password reset method in accordance with some embodiments;

FIG. 11 is a block diagram of functional modules of a payment password reset system in accordance with some embodiments;

FIG. 12 is a schematic diagram of an exemplary operating environment for a payment password reset system in accordance with some embodiments;

FIG. 13 is a schematic diagram of a client-server environment for payment password resetting in accordance with some embodiments;

FIG. 14 is a block diagram of an exemplary server for payment password resetting in accordance with some embodiments.

FIG. 15 is a block diagram of an apparatus of payment password resetting in accordance with some embodiments.

FIGS. 16A-16C are a flow chart of a method of payment password resetting at a payment server in accordance with some embodiments.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

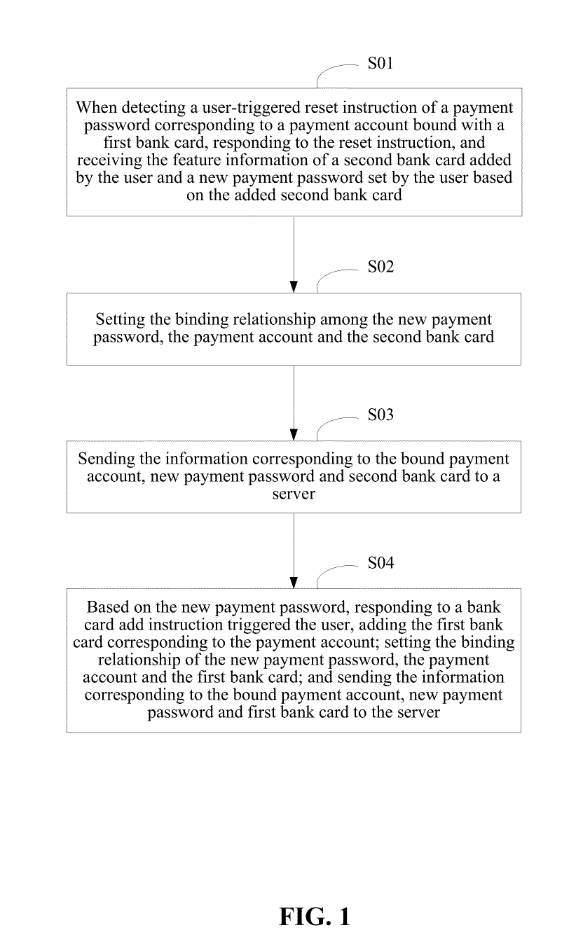

FIG. 1 is a flowchart of a payment password reset method in accordance with some embodiments. As shown in FIG. 1, the payment password reset method includes the following steps:

Step S01, when detecting a user-triggered instruction for resetting a payment password corresponding to a payment account bound with a first bank card, responding to the reset instruction, and receiving the feature information about a second bank card added by the user and a new payment password set by the user based on the added second bank card. This differs from conventional password resetting situations, where, when the reset instruction of a payment password corresponding to a payment account bound with a first bank card is received, the server respond to the reset instruction by receiving the password reset information for the first bank card. In the present disclosure, the server, in some cases (e.g., when the server lacks the authority to reset the password for the first bank card), responds to the password resetting instruction by requesting and receiving a new payment password for a second bank card that has yet to be bound to the payment account.

When a terminal receives a trigger instruction of the user for logging in a server corresponding to a third party payment platform based on a payment account and a login password, the terminal responding to the above trigger instruction, and sending the login password of the payment account input by the user to a server, so as to allow the server to verify whether the payment account and the login password input by the user are correct. When it is verified that the payment account and the login password input by the user are correct, the server sends a response to the terminal indicating that the information is correct. According to the response fed back from the server, the terminal provides a corresponding man-machine interaction interface, so as to allow the user to execute a corresponding operation (e.g., a payment operation) based on the logged-in payment account.

In some embodiments, bank cards that can be used to bind with the payment account include international bank cards or international credit cards (i.e. collectively, “international cards”) and domestically issued payment cards (e.g., a UnionPay card issued domestically in China). In some cases, an international card can be understood as a credit card issued by a card issuer and corresponding to an international credit card organization, and the above international card can be used freely at global organizations and websites capable of accepting credit cards of that brand, such as a Master™ international card, a Visa™ international card and the like. An international card is a representative type of cards that a server lacks authority to reset the payment password for. In some embodiments, the server may allow registration of other types of payment cards for payment transactions, but lack the authority to enable password resetting for such payment cards via the server.

In some embodiments, a third-party payment platform (e.g., a payment platform provided by the server) integrates multiple bank card payment modes in a single interface, serves as an intermediary or interface between different parties of an electronic commerce transaction and a financial institution (e.g., a bank or credit card issuer). The third party payment platform may take charge of the interfacing with the bank in transaction settlement. A customer pays a merchant via the third-party payment platform, and the third party payment platform provides for the merchant an interface platform capable of being compatible with multiple bank payment modes. Examples of such a payment platform include KuaiQian™ (99Bill), Lakala™, CaiFuTong (Tenpay), WangYiBao™ (ePay), WeiXin™ZhiFu (WeChat Payment), and the like.

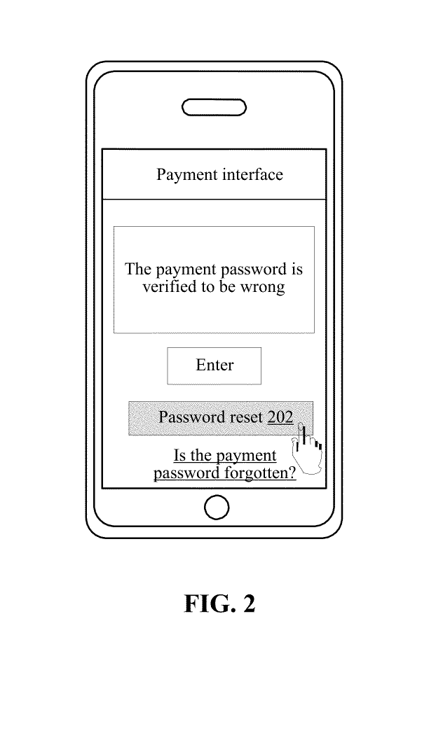

In some embodiments, the terminal device detects various operation instructions triggered by the user in real time; and when the terminal detects that the user has trigged an instruction for resetting the payment password corresponding to the payment account bound with a first international card (referred to as “international card a” hereinafter), the terminal responds to the user-triggered payment password reset instruction, and receives the feature information of a second bank card that is being added to the account by the user. At the same time, the terminal receives a new payment password set by the user based on the newly added second bank card. In some embodiments, the response of the terminal to the above payment password reset instruction can be implemented in the following manner: the terminal provides a control corresponding to the function for resetting the payment password, so as to allow the user to reset a payment password corresponding to the payment account based on the reset function control. For example, the terminal provides a “password reset” function control 202 on a terminal payment interface as shown in FIG. 2. When the terminal does not detect the reset instruction triggered by the user, the terminal sets the “password reset” function control to be in an unavailable state, i.e. the “password reset” function control is unavailable. For example, at this moment, the terminal displays the “password reset” function control in a grayed-out state. Of course, the terminal can also always set the “password reset” function control to be in an available state, and provides another way for the user to trigger the payment password reset instruction. For example, the terminal, when detecting that the user has touched the “password reset” function control 202 as shown in FIG. 2, determines that the user has triggered the instruction for resetting the payment password of the payment account bound with the international card a.

In some embodiments, the manner in which the terminal detects that the user triggers the instruction for resetting the payment password corresponding to the payment account bound with the international card a, includes but is not limited to the following implementations:

The terminal detects that the user triggers a control indicating that the user has forgotten the current payment password (e.g., selecting a hyperlink of “Is the payment password forgotten?” on the terminal payment interface as shown in FIG. 2); or the terminal has received notification from the server that the user has provided more than a threshold number (for example, 5 times) of consecutive incorrect inputs of the payment password within a preset duration (for example, within 3 minutes); or the terminal detects that the user triggers the “password reset” function control on the terminal payment interface as shown in FIG. 2, and so on.

Step S02, setting a binding relationship among the new payment password, the payment account and the second bank card.

When the terminal detects the user-triggered instruction for resetting the payment password corresponding to the payment account bound with the international card a, based on the provided reset function control, the terminal responds to the reset instruction of the payment password corresponding to the payment account triggered by the user. The terminal receives the feature information about a re-bound international card b of the payment account input by the user, such as information about the card number, the issue country and the like of the international card b. The terminal stores the feature information about the international card b. Based on the international card b newly bound with the payment account, the user sets a new payment password corresponding to the payment account. The terminal receives and stores the new payment password input by the user, and binds the new payment password set by the user and the international card b with the payment account and then stores same.

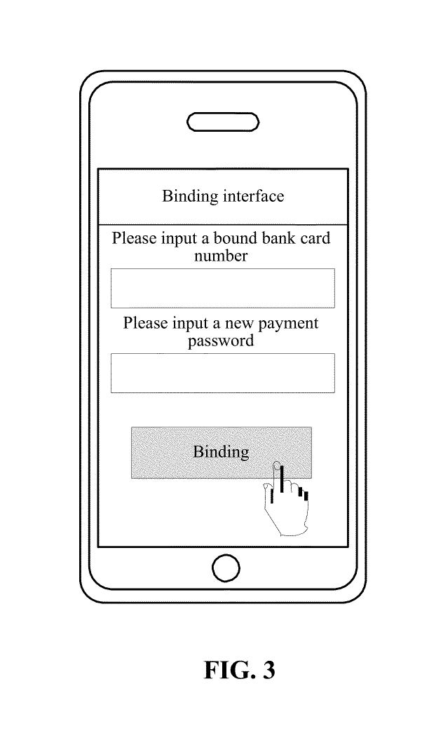

For example, the terminal receives the new payment password input by the user, and when the terminal detects that the user triggers an operation instruction for confirming the above information, the terminal sets and stores the binding relationship of the payment account with the international card b and the new payment password. For example, the user touches a “binding” control as shown in FIG. 3, when the terminal receives an operation instruction triggered by the user based on the “binding” control for confirming to bind the above information, the terminal binds the payment account with the international card b and the new payment password, and stores the binding relationship of the payment account with the international card b and the new payment password.

When detecting that a user triggers a reset instruction of the payment password corresponding to the payment account bound with the first bank card, the terminal of the embodiments of the present application responds to the reset instruction, receives the feature information about a second bank card added by the user and a new payment password set by the user based on the added second bank card, and sets a binding relationship among the new payment password, the payment account and the second bank card. In the prior art, when detecting that the user loses or forgets a payment password of a payment account bound with an international card, a terminal only provides a method for re-registering a payment account corresponding to a third party payment platform. In contrast to the prior art technique, as disclosed herein, when performing a payment operation based on a third party payment platform, a terminal is provided with a function to reset a payment password for a payment account of a bound international card, improving the intelligence of the terminal.

In some embodiments, the payment password reset method also includes after step S02 of the embodiment in FIG. 1:

Step S03, sending the information corresponding to the bound payment account, the new payment password and the second bank card to a server.

After the terminal sets and stores the binding relationship of the payment account with the new payment password and the international card b, the terminal sends the information corresponding to the bound payment account, the new payment password and the international card b to the server, so as to allow the server to store the above information, and facilitate the server in verifying the information used by the user when the user operates using a third party payment platform based on the terminal.

The terminal actively sends to the server updated information, such as the payment account, the new payment password and the international card b bound with the payment account, saving the operation flow whereby the server pulls the above information from the terminal.

In some embodiments, the payment password reset method of the present application also includes after step S03 of the embodiment in FIG. 1:

Step S04, based on the new payment password, responding to a bank card add instruction triggered by the user, and adding a first bank card corresponding to the payment account; setting a binding relationship among the new payment password, the payment account and the first bank card; and sending the information corresponding to the bound payment account, new payment password and first bank card to the server.

After the terminal sets and stores the binding relationship of the payment account with the new payment password and the international card b, based on the payment account and the new payment password, the terminal responds to the bank card add instruction issued from the user, and adds a new bank card for the payment account.

When one and the same payment account is only bound with one bank card, the following situation may occur: the bank card is unable to pay due to, for example, the balance in a debit card being insufficient or the huge overdraft of a credit card, thereby causing the waste of the payment time and the prolongation of the payment process. Thus, in order to prevent the occurrence of the above situation, in some embodiments, the terminal provides a function whereby one and the same payment account can be bound with multiple bank cards. Based on the above function provided by the terminal, the user can bind for one and the same payment account multiple bank cards.

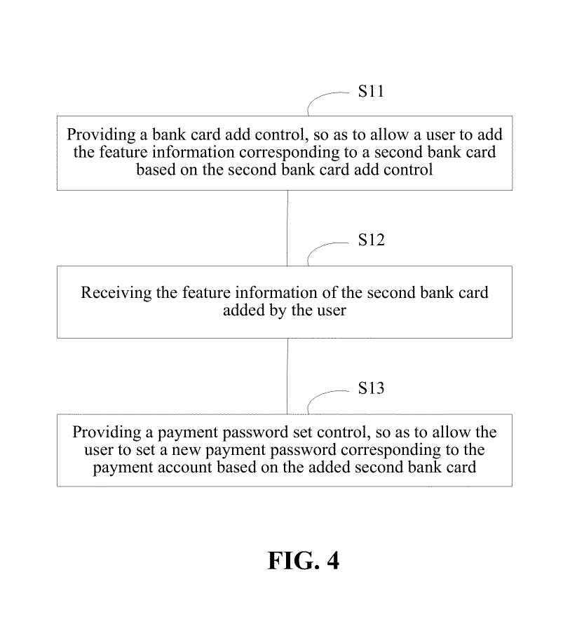

In some embodiments, a terminal responds to an instruction for a resetting a payment password by requesting and receives a second bank card added by the user and a new payment password in the payment password reset method. As shown in FIG. 4, in the payment password reset method, the terminal responds to a payment password reset instruction by requesting and receiving the feature information about a second bank card added by a user and a new payment password set by the user based on the newly-added second bank card, including:

Step S11, providing a bank card add control, so as to allow the user to add the feature information corresponding to the second bank card based on the bank card add control.

In some embodiments, the terminal responds to the instruction for resetting the payment password, the instruction being triggered by the user using the reset function control provided by the terminal. For example, in response to the user triggering an function control for a “password reset” operation instruction as shown in FIG. 2, the terminal provides a bank card add control to the user. As shown in FIG. 3, in a binding interface provided by the terminal, the terminal provides a bank card add control corresponding to “Please input a bound bank card number” to the user. Based on the bank card add control, the user can input the feature information about a new bank card to be added.

In some embodiments, the user, based on the bank card add control, can add a bank card of any type. For example, the user can add an international card, and the user of course can also add a UnionPay card (including a debit card and a credit card). In other words, the user can add a card (e.g., an international card) for which the server lacks password resetting authority, and a card (e.g., a UnionPay card) for which the server has password resetting authority. Since when adding a UnionPay card, the terminal needs to bind user identification information (such as user ID card number and the like) uniquely identifying the user identity information, and for a payment account bound with the UnionPay card, when the payment password is lost or forgotten, the terminal can easily retrieve the payment password or reset a payment password according to the user identification information filled by the user during binding. Thus, the implementation of the addition of the UnionPay card by the user is not described here in more detail and can be implemented with processes known in the art. The subsequent implementation process is described by taking the addition of an international card by the user as an example.

Step S12, receiving the feature information about the second bank card added by the user;

Step S13, providing a payment password set control, so as to allow the user to set a new payment password corresponding to the payment account based on the added second bank card.

The terminal receives the feature information about the second bank card (“international card b” for short hereinafter) added by user based on the bank card add control, such as the card number, the issue country, the issue country code and the like of the international card b. While providing the bank card add control, the terminal provides a payment password set control, so as to allow the user to set a new payment password corresponding to the payment account bound to the international card b. As shown in FIG. 3, in the binding interface displayed by the terminal, the terminal provides a payment password set control of “Please input a new payment password”, and based on the payment password set control provided by the terminal, the user sets a new payment password corresponding to the payment account.

In one preferred embodiment of the present application, while the terminal sets and stores the binding relationship of the payment account with the new payment password and the international card b, the terminal automatically deletes the binding relationship of the payment account with the original payment password and the international card a, and at the same time, deletes the feature information about the international card a bound with the payment account. For example, the terminal deletes information such as the card number, the issue country, the issue country code and the like of the international card a, so as to save the storage space of the terminal.

The operation of the whole execution process whereby the terminal executes a user-triggered payment password reset event corresponding to the payment account is simple and convenient, improving the man-machine interaction performance.

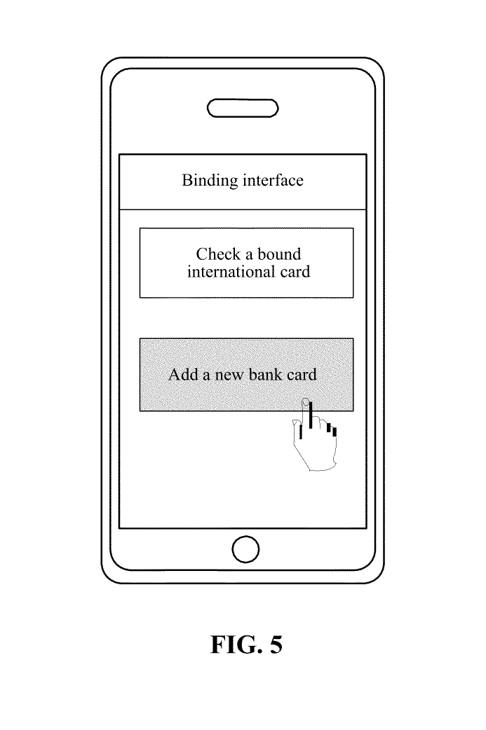

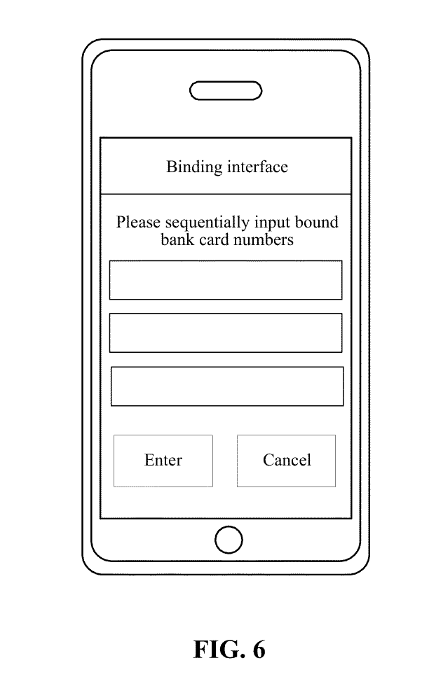

Based on the bank card add instruction triggered by the user, the terminal adds other multiple bank cards corresponding to the payment account, and as shown in FIG. 5, in the binding interface displayed by the terminal, based on a function control of “Check a bound international card” provided by the terminal, the user checks the international cards bound with the payment account; and based on a function control of “Add a new bank card”, the user can also bind for the payment account more international cards. When the terminal detects that the user has invoked the function control of “Add a new bank card”, the terminal provides a binding interface as shown in FIG. 6, on the binding interface displayed by the terminal as shown in FIG. 6, and based on a function control of “Please sequentially input bound bank card numbers”, the user can input the information for multiple international cards.

In some embodiments, when binding the international card b with the payment account, the terminal automatically unbinds the binding relationship with the international card a, and at the same time, deletes the feature information corresponding to the international card a stored in the terminal, thus, based on the payment account and the new payment password, the terminal can receive the information of the international card a again to re-bind the international card a with the payment account and the new payment password.

The terminal sends the binding relationship of the payment account and the new payment password and multiple bank cards, and the information corresponding to the payment account, the new payment password and the multiple bank cards to the server, so as to allow the server to store same.

In some embodiments, the terminal can bind multiple bank cards with one and the same payment account, and the terminal can also re-bind an unbound bank card with one and the same payment account based on the new payment password, improving the intelligence of the terminal.

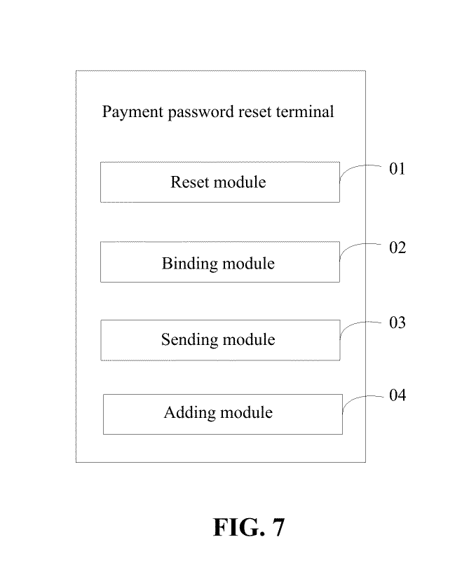

The present application also provides a first embodiment of a payment password reset terminal; and as shown in FIG. 7, the payment password reset terminal of the present application includes: a reset module 01 and a binding module 02.

The reset module 01 is used for, when detecting a user-triggered instruction for resetting a payment password corresponding to a payment account bound with a first bank card, responding to the reset instruction, and receiving the feature information about a second bank card added by the user and a new payment password set by the user based on the added second bank card.

When the terminal receives a trigger instruction whereby the user logs in a third party payment platform based on a payment account and a login password, the terminal responds to the above trigger instruction, and sends the login password of the payment account input by the user to a server, so as to allow the server to verify whether the payment account and the login password input by the user are correct. When verifying that the payment account and the login password input by the user are correct, the server sends the verified correct information to the terminal. According to the information fed back from the server, the terminal provides a corresponding man-machine interaction interface, so as to allow the user to execute a corresponding operation based on the logged-in payment account.

In some embodiments, the bank card includes an international card bank card (i.e. “international card”) and a UnionPay card issued in China. In some embodiments, the international card can be understood as a credit card issued by a card issuer and corresponding to an international credit card organization, and the above international card can be used freely at global organizations and websites capable of accepting credit cards of the brand, such as a Master international card, a visa international card and the like; and this embodiment and the following embodiments are all described by taking an international card as an embodiment.

The third party payment platform In some embodiments integrates various bank card payment modes on one interface, acts as an interface of respective parties of an electronic commerce transaction and a bank, and takes charge of the interfacing with the bank in transaction settlement, a customer pays for a merchant via the third party payment platform, and the third party payment platform provides for the merchant a interfacing platform capable of being compatible with multiple bank payment modes; such as a payment platform of 99Bill, Lakala, Tenpay, ePay, WeChat pay and the like.

The reset module 01 of the terminal detects various trigger instructions triggered by the user in real time; and when the terminal detects that the user triggers a reset instruction of the payment password corresponding to the payment account bound with the international card a, the reset module 01 responds to the user-triggered reset instruction of the payment password, and receives the feature information about the second bank card added by the user, at the same time, the reset module 01 receives the new payment password set by the user based on the added second bank card. In one particular implementation, the response of the reset module 01 to the above reset instruction of the payment password can be implemented in the following manner: the reset module 01 provides a reset function control corresponding to the payment password, so as to allow the user, based on the reset function control, to reset a payment password corresponding to the payment account; for example, the reset module 01 provides a “password reset” function control on the terminal payment interface as shown in FIG. 2; and when the reset module 01 does not detect the reset instruction triggered by the user, the reset module 01 sets the “password reset” function control to be in an unavailable state, i.e. the “password reset” function control is unavailable, for example, at this moment the reset module 01 displays the “password reset” function control to be gray. Of course, the reset module 01 can also always set the “password reset” function control to be in an available state, and provides another one implementation for the user to trigger the payment password reset instruction, for example, when detecting that the user touches the “password reset” function control as shown in FIG. 2, the reset module 01 identifies that the user triggers the reset instruction of the payment password of the payment account bound with the international card a.

In some embodiments, the reset module 01 detects that the user triggers a reset instruction of the payment password corresponding to the payment account bound with the international card a, including but not limited to the following implementations:

The reset module 01 detects that the user triggers an operation instruction corresponding to a quick link of “Is the payment password forgotten?” on the terminal payment interface as shown in FIG. 2; or the reset module 01 receives the number of times the user continuously inputs wrongly the payment password corresponding to the payment account within a preset duration (for example, within 3 minutes) reaches a preset threshold (for example, 5 times) sent from the server; or the reset module 01 detects that the user triggers the “password reset” function control on the terminal payment interface as shown in FIG. 2, and so on.

The binding module 02 is used for setting a binding relationship among the new payment password, the payment account and the second bank card.

When the reset module 01 detects the user-triggered instruction for resetting the payment password corresponding to the payment account bound with the international card a, based on the provided reset function control, the binding module 02 responds to the user-triggered reset instruction of the payment password corresponding to the payment account. The binding module 02 receives the feature information about the re-bound international card b of the payment account input by the user, information such as the card number, the issue country and the like of the international card b. The binding module 02 stores the feature information about the international card b, based on the international card b rebound with the payment account, the user sets a new payment password corresponding to the payment account, and the binding module 02 receives and stores the new payment password input by the user, and binds the new payment password set by the user and the international card b with the payment account and then stores same.

For example, the reset module 01 receives the new payment password input by the user, and when the binding module 02 detects that the user triggers an operation instruction for confirming the above information, the binding module 02 sets and stores the binding relationship of the payment account with the international card b and the new payment password; for example, the user touches the “binding” control as shown in FIG. 3, and when the terminal receives an operation instruction triggered by the user based on the “binding” control for confirming to bind the above information, the binding module 02 binds the payment account with the international card b and the new payment password, and stores the binding relationship of the payment account with the international card b and the new payment password.

When detecting that the user triggers an instruction for resetting a payment password corresponding to a payment account bound with a first bank card, the terminal of the embodiments of the present application responds to the reset instruction, receives the feature information about a second bank card added by the user and a new payment password set by the user based on the added second bank card; and sets a binding relationship among the new payment password, the payment account and the second bank card; and compared with the fact in the prior art that when detecting that a user loses or forgets a payment password of a payment account bound with an international card, a terminal only provides a method for re-registering a payment account corresponding to a third party payment platform, when the embodiments of the present application perform a payment operation based on a third party electronic payment platform, a terminal is provided with a function to reset a payment password for a payment account bound with an international card, improving the intelligence of the terminal.

In one preferred embodiments of the payment password reset terminal of the present application, the binding module 02 is also used for: providing a bank card add control, so as to allow a user to add the feature information corresponding to a second bank card based on the bank card add control; receiving the feature information about the second bank card added by the user; and providing a payment password set control, so as to allow the user to set a new payment password corresponding to the payment account based on the added second bank card.

The binding module 02 responds to the user-triggered reset instruction of the payment password based on the reset function control provided by the terminal; and for example, the binding module 02 responds to the user and triggers an operation instruction of the “password reset” function control as shown in FIG. 2, the binding module 02 provides a bank card add control, and as shown in FIG. 3, in the binding interface provided by the binding module 02, the binding module 02 provides a bank card add control corresponding to “Please input a bound bank card number”. Based on the bank card add control, the user can input the feature information about a bank card to be added.

In some embodiments, the user, based on the bank card add control, can add a bank card of any type, for example, the user can add an international card, and the user of course can also add a UnionPay card (including a debit card and a credit card); and when adding a UnionPay card, the terminal needs to bind user identification information (such as user ID card number and the like) uniquely identifying the user identity information, and for a payment account bound with the UnionPay card, when the payment password is lost or forgotten, the binding module 02 can easily retrieve the payment password or reset a payment password according to the user identification information filled by the user during binding; thus, the embodiments of the present application will not describe the implementation of the addition of the UnionPay card by the user any more, and the embodiments of the present application describe the subsequent implementation process by taking the addition of an international card by the user as an example.

The binding module 02 receives the feature information about an international card b″ added by a user based on the bank card add control, such as the card number, the issue country, the issue country code and the like of the international card b. The binding module 02 provides a payment password set control while providing the bank card control, so as to allow the user to set a new payment password corresponding to the payment account bound with the international card b. As shown in FIG. 3, in the binding interface displayed by the terminal, the terminal provides a payment password set control of “Please input a new payment password”, and based on the payment password set control provided by the user, the user sets a new payment password corresponding to the new payment account.

Furthermore, In some embodiments, the binding module 02 is also used for: unbinding the binding relationship of the payment account with the first bank card and original payment password, and deleting the feature information about the first bank card bound with the payment account.

In one preferred embodiment of the present application, while the binding module 02 sets and stores the binding relationship of the payment account with the new payment password and the international card b, the binding module 02 automatically deletes the binding relationship of the payment account with the original payment password and the international card a, and at the same time, deletes the feature information about the international card a bound with the payment account, for example, deletes information such as the card number, the issue country, the issue country code and the like of the international card a, so as to save the storage space of the terminal.

The operation of the whole execution process that the terminal of the embodiments of the present application executes a user-triggered payment password reset event corresponding to the payment account is simple and convenient, improving the man-machine interaction performance.

The embodiments of the present application provide a second embodiment of the payment password reset terminal; and as shown in FIG. 7, the payment password reset terminal of the present application also includes: a sending module 03, for sending the information corresponding to the bound payment account, new payment password and second bank card to the server.

After the binding module 02 sets and stores the binding relationship of the payment account with the new payment password and the international card b, the binding module 03 sends the information corresponding to the bound payment account, new payment password and the international card b to the server, so as to allow the server to store the above information, and facilitate the server in verifying the information used by the user when the user operates using the third party payment platform based on the terminal.

The terminal actively sends to the server updated information, such as the payment account, the new payment password and the international card bound b with the payment account, saving the operation flow whereby the server pulls the above information from the terminal.

The embodiments of the present application also provide a third embodiment of the payment password reset terminal; and as shown in FIG. 7, the payment password reset terminal of the present application also includes: an adding module 04, for, based on the payment password, responding to a bank card add instruction triggered by the user, and adding the first bank card corresponding to the payment account; setting a binding relationship among the new payment password, the payment account and the first bank card; and sending the information corresponding to the bound payment account, new payment password and first bank card to the server.

After the binding module 02 sets and stores the binding relationship of the payment account with the new payment password and the international card b, based on the payment account and the new payment password, the adding module 04 responds to the bank card add instruction issued from the user, and adds a new bank card for the payment account.

Since, when one and the same payment account is only bound with one bank card, the following situation may occur: the bank card is unable to pay due to, for example, the balance in a debit card being insufficient or the huge overdraft of a credit card, thereby causing the waste of the payment time and the prolongation of the payment process; and in order to prevent the occurrence of the above situation, In some embodiments, the terminal provides a function whereby one and the same payment account can be bound with multiple bank cards. Based on the above function provided by the terminal, the user can bind for one and the same payment account multiple bank cards.

Based on the bank card add instruction triggered by the user, the adding module 04 adds other multiple bank cards corresponding to the payment account, and as shown in FIG. 5, in the binding interface displayed by the terminal, based on the function control of “Check a bound international card” provided by the terminal, the user checks the international cards bound with the payment account; and the user can also bind for the payment account more international cards based on the function control of “Add a new bank card”. When the adding module 04 detects that the user touches the function control of “Add a new bank card”, the terminal provides a binding interface as shown in FIG. 6, and on the binding interface displayed by the terminal as shown in FIG. 6, based on the function control of “Please sequentially input bound bank card numbers”, the user can input multiple international cards.

In some embodiments, when binding the international card b with the payment, the adding module 02 automatically unbinds the binding relationship with the international card a, and at the same time deletes the feature information corresponding to the international card a stored in the terminal, thus, based on the payment account and the new payment password, the adding module 04 can receive same again to re-bind the international card a with the payment account and the new payment password.

The adding module 04 sends the binding relationship of the payment account and the new payment password with multiple bank cards, and the information corresponding to the payment account, the new payment password and the multiple bank cards to the server, so as to allow the server to store same.

In some embodiments, the terminal can bind multiple bank cards with one and the same payment account, and the terminal can also re-bind an unbound bank card with one and the same payment account based on the new payment password, improving the intelligence of the terminal.

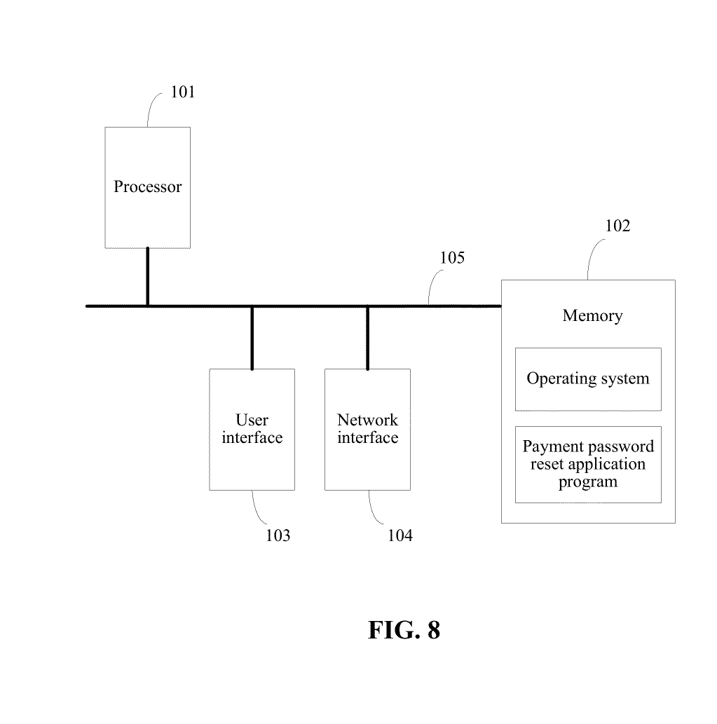

FIG. 8 shows a hardware structure of the payment password reset terminal in accordance with some embodiments. The payment password reset terminal includes: a processor 101, a memory 102, a user interface 103, a network interface 104 and a communication bus 105. The communication bus 105 is used for the communications among respective constituent components in the payment password reset terminal (“terminal” for short hereinafter), the user interface 103 is used for receiving information input by a user, and the user interface can be a wired interface and a wireless interface, such as a keyboard, a mouse and the like. The network interface 104 is used for verifying the mutual communications between the terminal and the outside, and the network interface can also include a wired interface and a wireless interface. The memory 102 can include one or more than one computer-readable storage medium, and it not only includes an internal memory, but also includes an external memory. The memory stores an operating system, a payment password reset application program and the like.

The processor 101 is used for calling the payment password reset application program in the memory 102, so as to execute the following operations:

The processor 101, when detecting a user-triggered instruction for resetting a payment password corresponding to a payment account bound with a first bank card via the user interface 103 or the network interface 104, responds to the reset instruction, and receives the feature information about a second bank card added by the user and a new payment password set by the user based on the added second bank card via the user interface 103; and

The processor 101 sets a binding relationship among the new payment password, the payment account and the second bank card via the communication bus 105.

The terminal provides a payment password reset function corresponding to a payment account; thus, when the payment password corresponding to the payment account bound with a bank card is lost, a new payment password corresponding to the payment account can also be reset, without the need of re-registering a new payment account.

Furthermore, the processor 101 is also used for calling the payment password reset application program in the memory 102, so as to execute the following operations: providing a bank card add control via the user interface 103, so as to allow the user to add the feature information corresponding to the second bank card based on the bank card add control; receiving the feature information about the second bank card added by the user via the user interface 103; and providing a payment password set control via the network interface 104, so as to allow the user to set a new payment password corresponding to the payment account based on the added second bank card.

Furthermore, the processor 101 is also used for calling the payment password reset application program in the memory 102, so as to execute the following operations: utilizing the communication bus 105 to unbind the binding relationship of the payment account with the first bank card and original payment password, and deleting the feature information about the first bank card bound with the payment account stored in the memory 102.

Furthermore, the processor 101 is also used for calling the payment password reset application program in the memory 102, so as to execute the following operations: sending the information corresponding to the bound payment account, new payment password and second bank card to a server via the network interface 104.

Furthermore, the processor 101 is also used for calling the payment password reset application program in the memory 102, so as to execute the following operations: based on the new payment password, responding to a user-triggered bank card add instruction via the user interface 103, and adding the first bank card corresponding to the payment account by using the communication bus 105; setting a binding relationship among the new payment password, the payment account and the first bank card; and sending the information corresponding to the bound payment account, new payment password and first bank card to the server via the network interface 104.

Furthermore, the processor 101 is also used for calling the payment password reset application program in the memory 102, so as to execute the following operations: receiving via the network interface 104 information sent from the server that the number of times the user continuously inputs wrongly the payment password corresponding to the payment account reaches a preset threshold, and triggering the reset instruction of the payment password; or, when detecting via the user interface 103 that the user triggers the password reset control on the terminal, triggering the reset instruction of the payment password.

The operation of the whole execution process that the terminal executes the user-triggered payment password reset event of the payment account is simple and convenient, improving the man-machine interaction performance and the intelligence of the terminal.

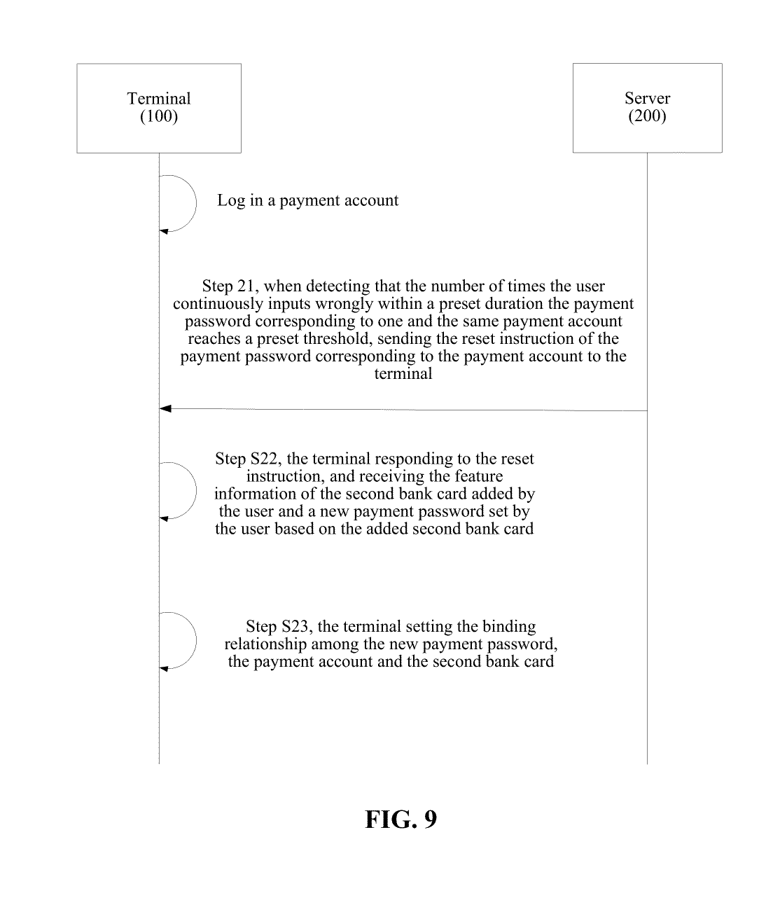

The embodiments of the present application provide a schematic flowchart of a fourth embodiment of the payment password reset method; and as shown in FIG. 9, the payment password reset method of the present application includes the follows steps:

Step 21, when the server detects that the number of times the user continuously inputs wrongly within a preset duration a payment password corresponding to one and the same payment account reaches a preset threshold, sending a reset instruction of the payment password corresponding to the payment account to the terminal.

When the terminal receives a trigger instruction of the user for logging in a server corresponding to a third party payment platform based on a payment account and a login password, the terminal responding to the above trigger instruction, and sending the login password of the payment account input by the user to the server, so as to allow the server to verify whether the payment account and the login password input by the user are correct. When verifying that the payment account and the login password input by the user are correct, the server sends the verified correct information to the terminal. According to the information fed back from the server, the terminal provides a corresponding man-machine interaction interface, so as to allow the user to execute a corresponding operation based on the logged-in payment account.

When the server detects that the number of times the user continuously inputs wrongly within a preset duration (for example, within 3 minutes) a payment password corresponding to the payment account reaches a preset threshold (for example, 5 times), the server sends the reset instruction of the payment password corresponding to the payment account to the terminal.

Step S22, the terminal responding to the reset instruction, and receiving the feature information about the second bank card added by the user and a new payment password set by the user based on the added second bank card.

When the terminal receives the reset instruction sent from the server, the terminal responds to the reset terminal of the payment password, and receives the feature information about the second bank card added by the user, and at the same time receives a new payment password set by the user based on the added second bank card. In one particular implementation, the response of the terminal to the above reset instruction of the payment password can be implemented in the following manner: the terminal provides a reset function control corresponding to the payment password, so as to allow the user, based on the reset function control, to reset a payment password corresponding to the payment account; and for example, the terminal provides a “password reset” function control on a terminal payment interface of the terminal as shown in FIG. 2, so as to allow the user to reset a payment password corresponding to the payment account.

In some embodiments, the bank card includes an international card bank card (i.e. “international card”) and a UnionPay card issued in China; In some embodiments, the international card can be understood as a credit card issued by a card issuer and corresponding to an international credit card organization, and the above international card, can be used freely at global organizations and websites capable of accepting credit cards of the brand, such as a Master international card, a visa international card and the like. The third party payment platform integrates various bank card payment modes on one interface, acts as an interface of respective parties of an electronic commerce transaction and a bank, and takes charge of the docking with the bank in transaction settlement, a customer pays for a merchant via the third party payment platform, and the third party payment provides for the merchant a docking platform capable of being compatible with multiple bank payment modes; such as a payment platform of 99Bill, Lakala, Tenpay, ePay, WeChat pay and the like.

Step S23, the terminal setting a binding relationship among the new payment password, the payment account and the second bank card.

When the terminal detects the user-triggered reset instruction of the payment password corresponding to the payment account bound with the international card a, based on the provided reset function control, the terminal responds to the reset instruction of the payment password corresponding to the payment account triggered by the user. The terminal receives the feature information about a re-bound international card b of the payment account input by the user, information such as the card number, the issue country and the like of the international card b. The terminal stores the feature information about international card b, based on the international card b rebound with the payment account, the user sets a new payment password corresponding to the payment account, and the terminal receives and stores the new payment password input by the user, and binds the new payment password set by the user and the international card b with the payment account and then stores same.

For example, the terminal receives a new payment password input by the user, and when the terminal detects that the user triggers an operation instruction for confirming the above information, the terminal sets and stores the binding relationship of the payment account and the international card b and the new payment password; for example, the user touches the “binding” control as shown in FIG. 3, when the terminal receives an operation instruction triggered by the user based on the “binding” control for confirming to bind the above information, the terminal binds the payment account with the international card b and the new payment password, and stores the binding relationship of the payment account with the international card b and the new payment password.

When the server of the embodiments of the present application detects that the number of times the user continuously inputs wrongly within a preset duration a payment password corresponding to one and the same payment account reaches a preset threshold, sends the reset instruction of the payment password corresponding to the payment account to the terminal; and the terminal responds to the reset instruction, and receives the feature information about the second bank card added by the user and a new payment password set by the user based on the added second bank card; and sets a binding relationship among the new payment password, the payment account and the second bank card. When performing a payment operation based on a third party electronic payment platform, the terminal is provided with a function for resetting a payment password for a payment account bound with an international card, improving the intelligence of the terminal.

Furthermore, in one embodiment of the payment password reset method of the present application, the terminal executes a payment password reset event corresponding to a payment account, including: the terminal responds to the reset instruction of the payment password triggered by the user based on the reset function control provided by the terminal; for example, the terminal responds to the operation instruction of the “password reset” function control as shown in FIG. 2, the terminal provides a bank card add control, and as shown in FIG. 3, in the binding interface provided by the terminal, the terminal provides a bank card add control corresponding to “Please input a bound bank card number”. Based on the bank card add control, the user can input the feature information about a bank card to be added.

In some embodiments, the user, based on the bank card add control, can add a bank card of any type, for example, the user can add an international card, and the user of course can also add a UnionPay card (including a debit card and a credit card); and since when adding a UnionPay card, the terminal needs to bind user identification information (such as user ID card number and the like) uniquely identifying the user identity information, and for a payment account bound with the UnionPay card, when the payment password is lost or forgotten, the terminal can easily retrieve the payment password or reset a payment password according to the user identification information filled by the user during binding; thus, the embodiments of the present application will not describe the embodiments of the addition of the UnionPay card by the user any more, and the embodiments of the present application describe the subsequent implementation process by taking the addition of an international card by the user as an embodiment.

The terminal receives the feature information about an international card b added by the user based on the bank card add control, such as the card number, the issue country, the issue country code and the like of the international card b. While providing the bank card add control, the terminal provides a payment password set control, so as to allow the user, based on the added international card b, to set a new payment password corresponding to the payment account bound with the international card b. As shown in FIG. 3, in the binding interface displayed by the terminal, the terminal provides a payment password set control of “Please input a new payment password’, and based on the payment password set control provided by the user, the user sets a new payment password corresponding to the new payment account.

In some embodiments, while the terminal sets and stores the binding relationship of the payment account with the new payment password and the international card b, the terminal automatically deletes the binding relationship of the payment account with the original payment password and the international card a, and at the same time, deletes the feature information about the international card a bound with the payment account, for example, deletes information such as the card number, the issue country, the issue country code and the like of the international card a, so as to save the storage space of the terminal.

The operation of the whole execution process that the terminal of the embodiments of the present application executes a user-triggered payment password reset event corresponding to the payment account is simple and convenient, improving the man-machine interaction performance.

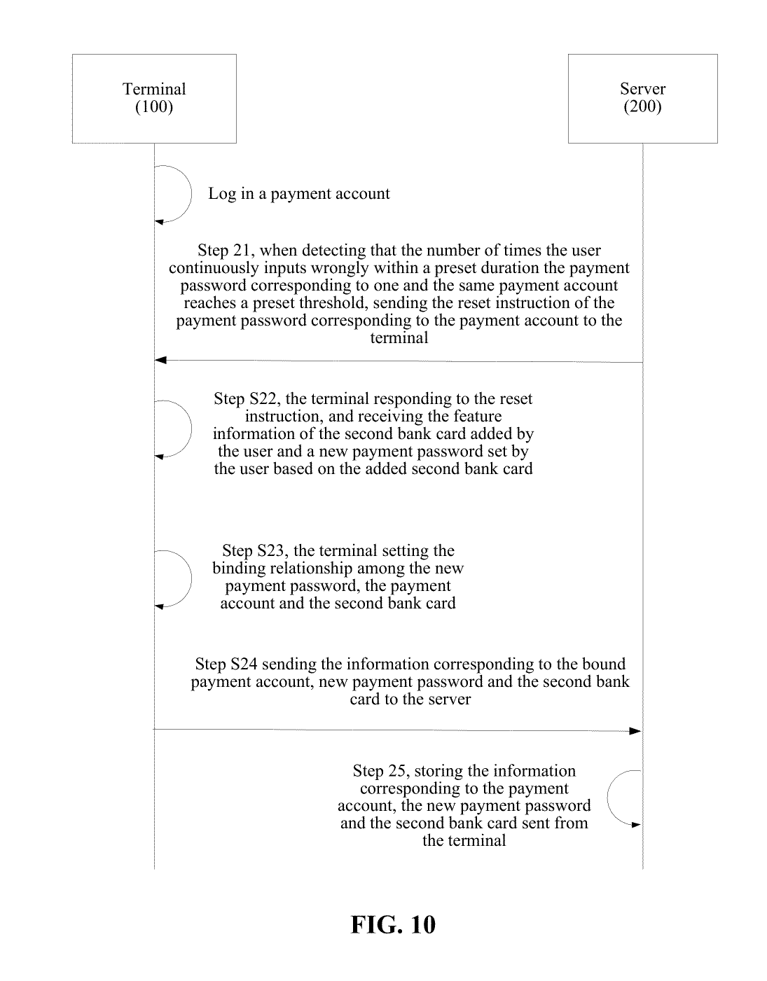

FIG. 10 shows a payment password reset method in accordance with some embodiments. As shown in FIG. 10, the payment password reset method of the present application also includes after step S23 of the embodiment in FIG. 9:

Step S24, the terminal sending the information corresponding to the bound payment account, new payment password and second bank card to the server.

After the terminal sets and stores the binding relationship of the payment account and the new payment password and the international card b, the terminal sending the information corresponding to the bound payment account and the new payment password and the international card b to the server.

Step 25, the server storing the information corresponding to the payment account, new payment password and second bank card sent from the terminal.

The terminal stores the binding relationship of the payment account, new payment password and second international card sent from the terminal, and at the same time stores the information corresponding to the payment account, new payment password and second international card, and when the user operates based on the terminal by using a third party payment platform, the server verifies the information used by the user according to the stored above formation.

The terminal actively sends to the server updated information, such as a payment account, a new payment password and an international card b bound with the payment account, saving the operation flow whereby the server pulls the above information from the terminal.

Furthermore, in one embodiment of the payment password reset method of the present application, after the terminal sets and stores the binding relationship of the payment account with the new payment password and the international card b, based on the payment account and the new payment password, the terminal responds to a bank card add instruction issued from the user, and adds a new bank card for the payment account.

Since when one and the same payment account is only bound with one bank card, the following situation may occur: the bank card is unable to pay due to, for example, the balance in a debit card being insufficient or the huge overdraft of a credit card, thereby causing the waste of the payment time and the prolongation of the payment process; and in order to prevent the occurrence of the above situation, In some embodiments, the terminal provides a function whereby one and the same payment account can be bound with multiple bank cards. Based on the above function provided by the terminal, the user can bind for one and the same payment account multiple bank cards.

Based on a bank card add instruction triggered by the user, the terminal adds other multiple bank cards corresponding to the payment account, and as shown in FIG. 5, in the binding interface displayed by the terminal, based on the function control of “Check a bound international card” provided by the terminal, the user checks the international cards bound with the payment account; and the user can also bind for the payment account more international cards based on a function control of “Add a new bank card”. When the terminal detects that the user touches the function control of “Add a new bank card”, the terminal provides a binding interface as shown in FIG. 6, and on the binding interface displayed by the terminal as shown in FIG. 6, based on a function control of “Please sequentially input bound bank card numbers, the user can input multiple international cards.

In some embodiments, since when binding the international card b with the payment account, the terminal automatically unbinds the binding relationship with the international card a, and at the same time, deletes the feature information corresponding to the international card a stored in the terminal, thus, based on the payment account and the new payment password, the terminal can receive same again to re-bind the international card a with the payment account and the new payment password.

The terminal sends the binding relationship of the payment account and the new payment password with multiple bank cards, and the information corresponding to the payment account, the new payment password and the multiple bank cards to the server, so as to allow the server to store same.

In some embodiments, the terminal can bind multiple bank cards with one and the same payment account, and the terminal can also re-bind an unbound bank card with one and the same payment account based on the new payment password, improving the intelligence of the terminal.

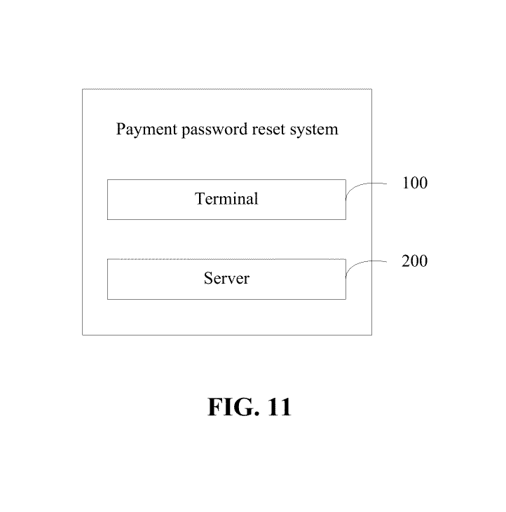

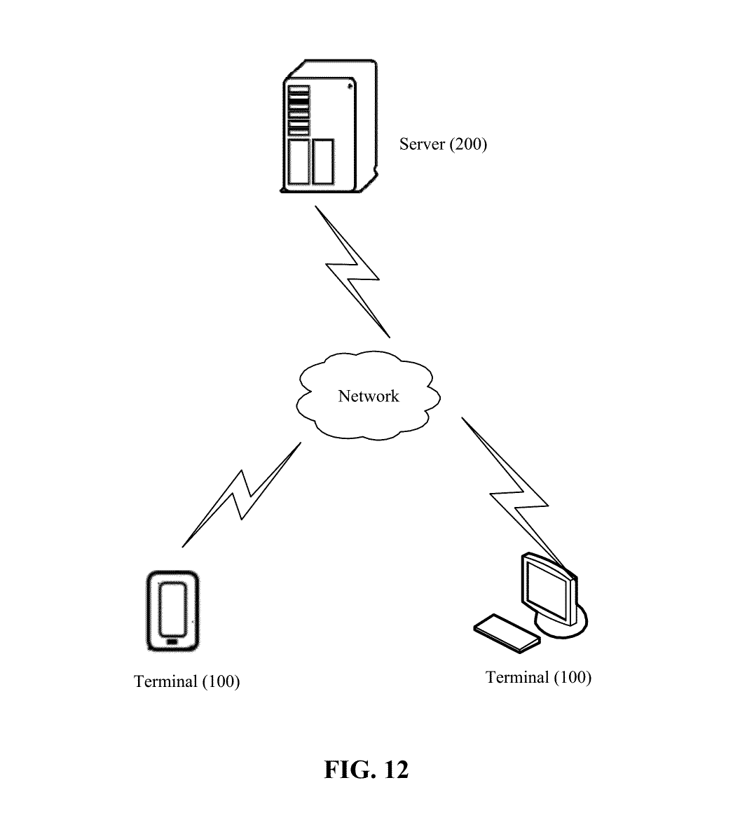

FIG. 11 provides a schematic diagram of functional modules of one embodiment of a payment password reset system of the present application; as shown in FIG. 11, the payment password reset system of the present application includes a terminal 100 and a server 200; the schematic diagrams of the operating environments of the terminal 100 and the server 200 are as shown in FIG. 12, and FIG. 12 is a schematic diagram of the operating environment of one embodiment of a payment password reset system of the present application; and as shown in FIG. 12. In some embodiments, the terminal 100 performs communications and data interaction with the server 200 via the Internet.

In some embodiments, the terminal 100 includes but not limited to: mobile devices such as a PC (personal computer), a smart phone (such as Android mobile phone, iOS mobile phone, etc.), a tablet PC, a palm PC and a mobile interconnect device (MID), PAD and the like.

In one embodiment of the payment password reset system of the present application, the server 200 is used for: when detecting that the number of times the user continuously inputs wrongly within a preset duration a payment password corresponding to one and the same payment account reaches a preset threshold, sending a reset instruction of the payment password of the payment account to the terminal 100; and when the terminal 100 receives a trigger instruction of the user for logging in the server 200 corresponding to a third party payment platform based on a payment account and a login password, the terminal 100 responds to the above trigger instruction, and sending the login password of the payment account input by the user to the server 200, so as to allow the server 200 to verify whether the payment account and the login password input by the user are correct. When verifying that the payment account and the login password input by the user are correct, the server 200 sends the verified correct information to the terminal 100. The terminal 100, according to the information fed back from the server 200, provides a corresponding man-machine interaction interface, so as to allow the user to execute a corresponding operation based on the logged in payment account.

When the server 200 detects that the number of times the user continuously inputs wrongly within a preset duration (for example, within 3 minutes) a payment password corresponding to one and the same payment account reaches a preset threshold (for example, 5 times), the server 200 sends the reset instruction of the payment password corresponding to the payment account to the terminal 100.

The terminal 100 is used for: responding to the reset instruction, receiving the feature information about the second bank card added by the user and a new payment password set by the user based on the added second bank card, and setting a binding relationship among the new payment password, the payment account and the second bank card.

When the terminal 100 receives the reset instruction sent from the server 200, the terminal 100 responds to the reset instruction of the payment password, and receives the feature information about the second bank card added by the user, and at the same time receives a new payment password set by the user based on the added second bank card. In one particular implementation, the response of the terminal 100 to the above reset instruction of the payment password can be implemented in the following manner: the terminal 100 provides a reset function control corresponding to the payment password, so as to allow the user to reset a payment password corresponding to the payment account based on the function control; for example, the terminal 100 provides the “password reset” function control on the terminal 100 payment interface as shown in FIG. 2, so as to allow the user to reset a payment password corresponding to the payment account.

In some embodiments, the bank card includes an international card bank card (i.e. “international card”) and a UnionPay card issued in China. In some embodiments, the international card can be understood as a credit card issued by a card issuer and corresponding to an international credit card organization, and the above international card, can be used freely at global organizations and websites capable of accepting credit cards of the brand, such as a Master international card, a visa international card and the like. The third party payment platform integrates various bank card payment modes on one interface, acts as an interface of respective parties of an electronic commerce transaction and a bank, and takes charge of the docking with the bank in transaction settlement, a customer pays for a merchant via the third party payment platform, and the third party payment provides for the merchant a docking platform capable of being compatible with multiple bank payment modes; such as a payment platform of 99Bill, Lakala, Tenpay, ePay, WeChat pay and the like.

When the terminal 100 detects a user-triggered reset instruction of the payment password corresponding to the payment account bound with the international card a, based on the provided reset function control, the terminal 100 responds to the user-triggered reset instruction of the payment password corresponding to the payment account. The terminal 100 receives the feature information about a re-bound international card b of the payment account input by the user, information such as the card number, the issue country and the like of the international card b. The terminal 100 stores the feature information about international card b, based on the international card b rebound with the payment account, the user sets a new payment password corresponding to the payment account, and the terminal 100 receives and stores the new payment password input by the user, and binds the new payment password set by the user and the international card b with the payment account and then stores same.

For example, the terminal 100 receives the new payment password input by the user, and when the terminal 100 detects that the user triggers an operation instruction for confirming the above information, the terminal 100 sets and stores the binding relationship of the payment account and the international card b and the new payment password; for example, the user touches the “binding control” as shown in FIG. 3, when the terminal 100 receives an operation instruction triggered by the user based on the “binding” control for confirming to bind the above information, and the terminal 100 binds the payment account with the international card b and the new payment password, and stores the binding relationship of the payment account with the international card b and the new payment password.

When detecting that the number of times the user continuously inputs wrongly within a preset duration a payment password corresponding to one and the same payment account reaches a preset threshold, the server of the embodiments of the present application sends a reset instruction of the payment password corresponding to the payment account to the terminal; and the terminal responds to the reset instruction, receives the feature information about the second bank card added by the user and a new payment password set by the user based on the added second bank card; and sets a binding relationship among the new payment password, the payment account and the second bank card; when performing a payment operation based on a third party electronic payment platform, the terminal is provided with a function for resetting a payment password for a payment account bound with an international card, improving the intelligence of the terminal.

Furthermore, the terminal 100 is also used for: providing a bank card add control, so as to allow a user to add the feature information corresponding to a second bank card based on the bank card add control; receiving the feature information about the second bank card added by the user; and providing a payment password set control, so as to allow the user to set a new payment password corresponding to the payment account based on the added second bank card.

Furthermore, the terminal 100 is also used for: after setting a binding relationship of the new payment password, the payment account and the second bank card, unbinding the binding relationship of the payment account with the first bank card and original payment password, and deleting the feature information about the first bank card bound with the payment account.

Furthermore, the terminal 100 is also used for: sending the information corresponding to the bound payment account, new payment password and second bank card to a server 200; and the server 200 is also used for: storing the information corresponding to the payment account, new payment password and second bank card sent from the terminal 100.

Furthermore, the terminal 100 is also used for: after sending the information about the bound payment account, new payment password and second bank card to the server 200, based on the new payment password, responding to a bank card add instruction triggered by the user, and adding the first bank card corresponding to the payment account; setting a binding relationship among the new payment password, the payment account and the first bank card; and sending the information corresponding to the bound payment account, new payment password and first bank card to the server 200.

The server 200 is also used for: storing the information corresponding to the payment account, new payment password and first bank card sent from the terminal 100.

The operation of the whole execution process that the terminal of the embodiments of the present application executes a user-triggered payment password reset event corresponding to the payment account is simple and convenient, improving the intelligence of the terminal and the man-machine interaction performance; and furthermore, since the terminal sends the bound payment account, new payment password and the international card to the server, and the set above information is stored in the server, which facilitates that the server executes a corresponding electronic payment operation according to the set information.

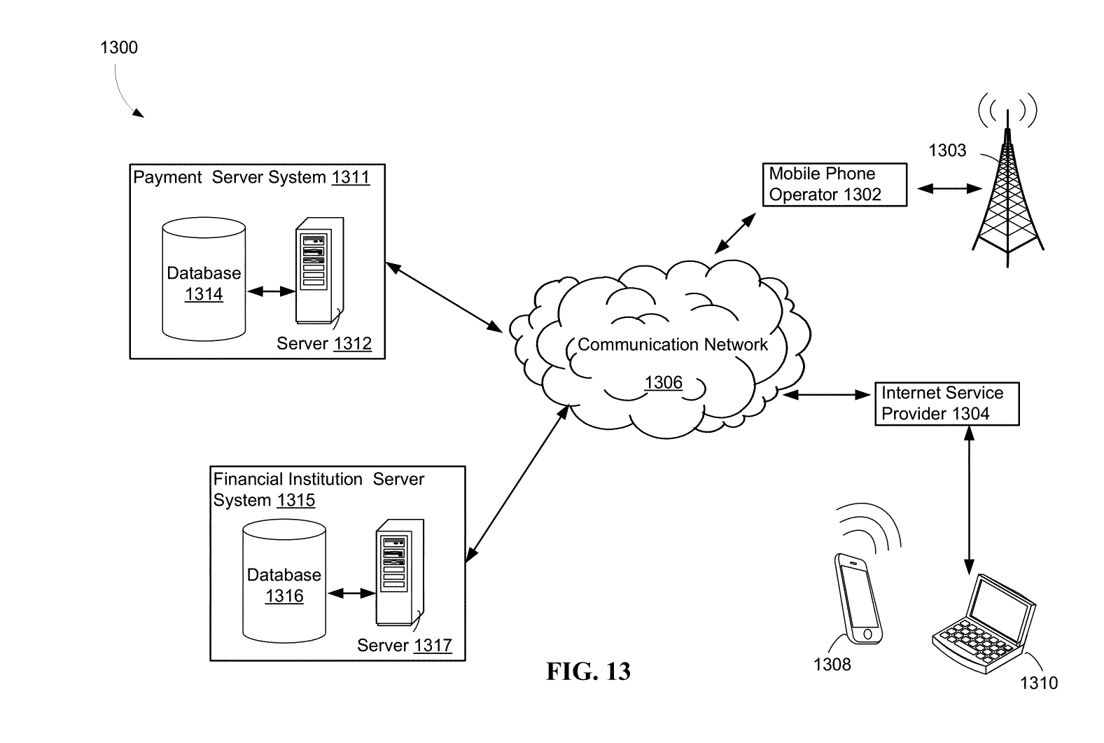

FIG. 13 is a diagram of a client-server environment 1300 for identity authentication, in accordance with some implementations of the present application. While certain specific features are illustrated, those skilled in the art will appreciate from the present disclosure that various other features have not been illustrated for the sake of brevity and so as not to obscure more pertinent aspects of the implementations disclosed herein. To that end, the client-server environment 1300 includes one or more mobile phone operators 1302, one or more internet service providers 1304, and a communications network 1306.

The mobile phone operator 1302 (e.g., wireless carrier), and the Internet service provider 1304 are capable of being connected to the communication network 1306 in order to exchange information with one another and/or other devices and systems. Additionally, the mobile phone operator 1302 and the Internet service provider 1304 are operable to connect client devices to the communication network 1306 as well. For example, a smart phone 1308 is operable with the network of the mobile phone operator 1302, which includes for example, a base station 1303. Similarly, for example, a laptop computer 1310 (or tablet, desktop, smart television, workstation or the like) is connectable to the network provided by an Internet service provider 1304, which is ultimately connectable to the communication network 1306.

The communication network 1306 may be any combination of wired and wireless local area network (LAN) and/or wide area network (WAN), such as an intranet, an extranet, including a portion of the Internet. It is sufficient that the communication network 1306 provides communication capability between client devices (e.g., smart phones 1308 and personal computers 1310) and servers. In some implementations, the communication network 1306 uses the HyperText Transport Protocol (HTTP) to transport information using the Transmission Control Protocol/Internet Protocol (TCP/IP). HTTP permits a client device to access various resources available via the communication network 1306. However, the various implementations described herein are not limited to the use of any particular protocol.

In some implementations, the client-server environment 1300 further includes a payment server system 1311. Within the payment server system 1311, there is a server computer 1312 (e.g., a network server such as a web server) for receiving and processing data received from the client device 1308/1310 (e.g., card information for one or more alternate payment cards, or an alias password for a first payment card). In some implementations, the payment server system 1311 stores (e.g., in a database 1314) and maintains payment profile information corresponding to one or more user accounts for users of a client device 1308/1310 or an application running on client device 1308/1310. In some embodiments, the payment server system 1311 is part of a general mobile payment system or a general mobile banking/finance system or a general e-commerce system.

In some implementations, the payment server system 1311 sends and receives various communications to and from a client device 1308/1310. In some embodiments, these communications or the information in these communications are stored and retrieved from database 1314. In some embodiments, the payment server system 1311 receives a payment card password reset request for a first payment card, from a first user of client device 1308/1310 (e.g., request to reset a PIN for a debit card) and in some embodiments, the payment server system 1311 determines if the payment server system 1311 has authority to reset the payment password. In some embodiments, the payment server system 1311 communicates with another server system or computer system, such as financial institution server system 1315 to determine if it has authority to reset the payment password. In some embodiments, financial institution server system 1315 comprises one or more databases 1316 and one or more servers 1317. In some embodiments, the payment server system 1311 determines it does not have authority to reset the payment card password and consequently sends to and receives from the client device 1308/1310 various forms of communications (e.g., information prompts and responses). In some embodiments, the payment server system 1311 stores (e.g., in database 1314) card information (e.g., card number, name on card, PIN, billing address etc.) for one or more payment cards associated with a first user account.

Those skilled in the art will appreciate from the present disclosure that any number of such devices and/or systems may be provided in a client-server environment, and particular devices may be altogether absent. In other words, the client-server environment 1100 is merely an example provided to discuss more pertinent features of the present disclosure. Additional server systems, such as domain name servers and client distribution networks may be present in the client-server environment 1300, but have been omitted for ease of explanation.

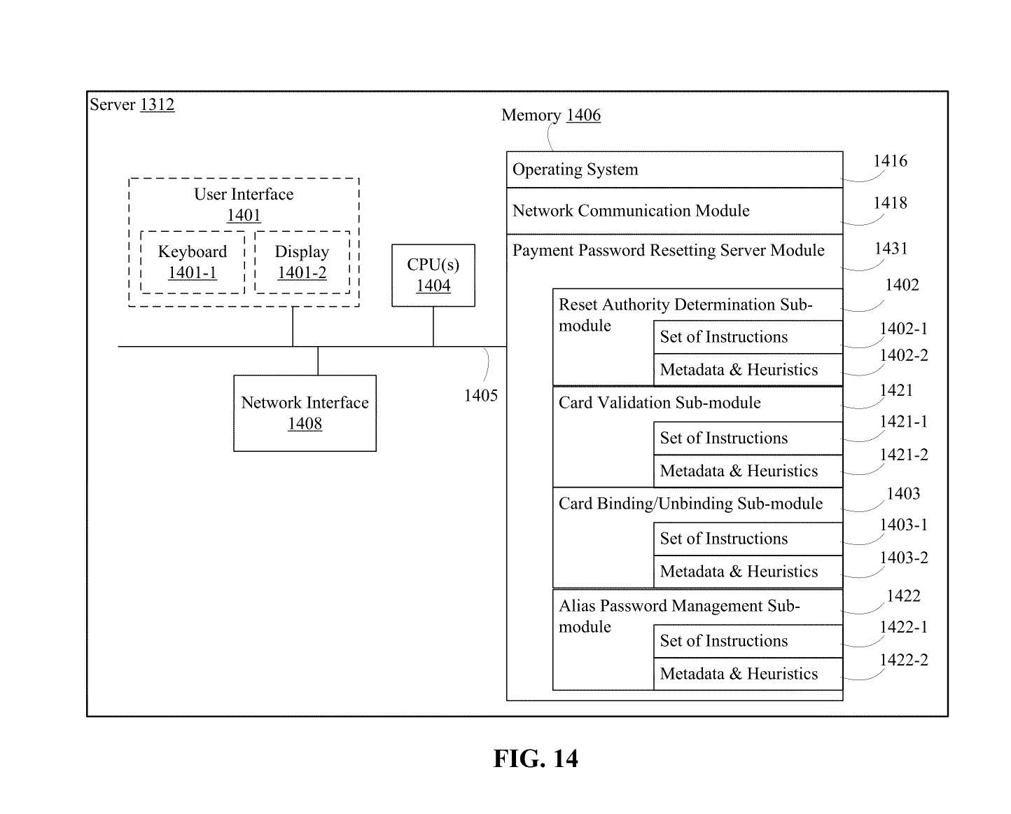

FIG. 14 is a diagram of an example implementation of the payment server 1312, in accordance with some implementations of the present application. While certain specific features are illustrated, those skilled in the art will appreciate from the present disclosure that various other features have not been illustrated for the sake of brevity and so as not to obscure more pertinent aspects of the implementations disclosed herein.

Server 1312 includes one or more processing units (CPU's) 1404, one or more network or other communications interfaces 1408, an optional user interface 1401 (optionally comprising elements such as a keyboard 1401-1 or display 1401-2), memory 1406, and one or more communication buses 1405 for interconnecting these and various other components. The communication buses 1405 may include circuitry (sometimes called a chipset) that interconnects and controls communications between system components. Memory 1406 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1406 may optionally include one or more storage devices remotely located from the CPU(s) 1404. Memory 1406, including the non-volatile and volatile memory device(s) within memory 1406, comprises a non-transitory computer readable storage medium.

In some implementations, memory 1406 or the non-transitory computer readable storage medium of memory 1406 stores the following programs, modules and data structures, or a subset thereof including an operating system 1416, a network communication module 1418, and an identity authentication server module 1431.

The operating system 1416 includes procedures for handling various basic system services and for performing hardware dependent tasks.

The network communication module 1418 facilitates communication with other devices via the one or more communication network interfaces 1408 (wired or wireless) and one or more communication networks, such as the internet, other wide area networks, local area networks, metropolitan area networks, and so on.

In some implementations, the payment password resetting server module 1431 includes a reset authority determination sub-module 1402 for receiving, a payment card password reset request corresponding to a first payment card associated with a first user account from a client device 1108/1110 and determining if the payment server has authority to reset the payment card password for the first payment card. To this end, the reset authority determination sub-module 1402 includes a set of instructions 1402-1 and, optionally, metadata 1402-2. In some implementations, the payment password resetting server module 1431 includes a card validation sub-module 1421 having a set of instructions 1421-1 (e.g., to determine the validity of card information corresponding to one or more alternate payment cards received from a device 1108/1110) and, optionally, metadata 1421-2, as well as a card binding/unbinding sub-module 1403 having a set of instructions 1403-1 (e.g., for optionally associating or dissociating a payment card from the first user account) and optionally metadata 1403-2. In some implementations, the payment password resetting server module 1431 includes an alias password management sub-module 1422 having a set of instructions 1422-1 (e.g., for optionally prompting creation of and storing, for example in database 1314, one or more alias passwords associated with one or more payment cards and user accounts) and, optionally, metadata 1422-2.

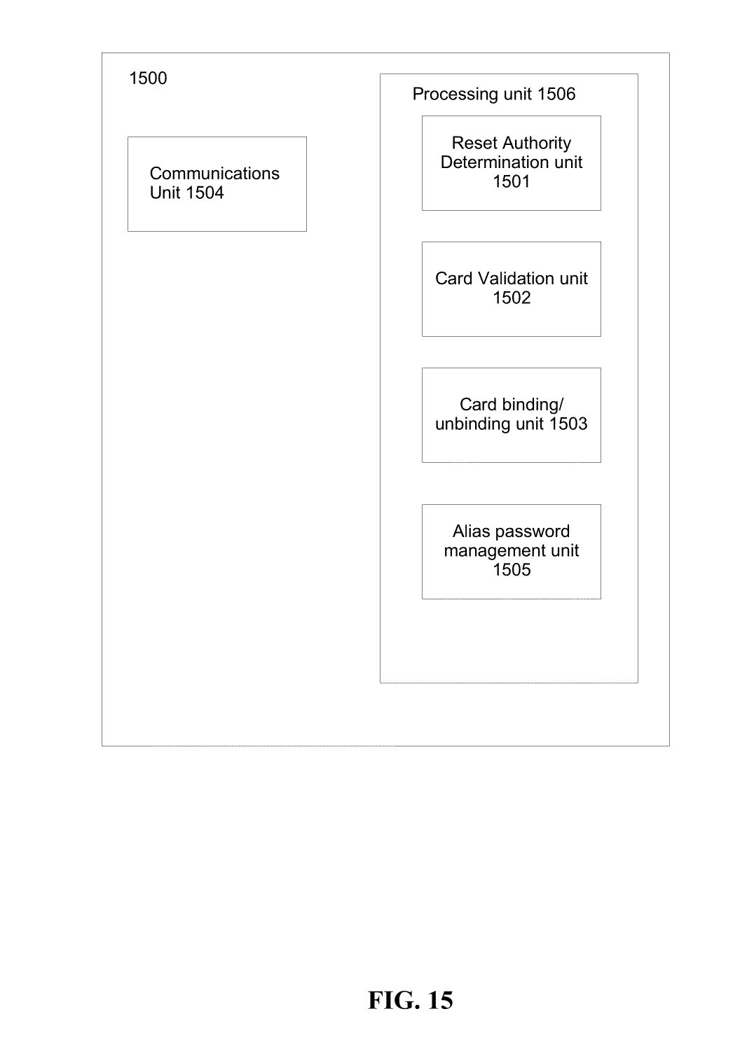

FIG. 15 is a structural diagram of a realization apparatus 1500 of identity authentication in accordance with some implementations of the present application.

As is shown in FIG. 15, this device includes: a communications unit 1504, and a processing unit 1506 comprising a reset authority determination unit 1501, card validation unit 1502, card binding/unbinding unit 1503, and alias password management unit 1505, among which:

Reset authority determination unit 1501: configured to receive, a payment card password reset request corresponding to a first payment card associated with a first user account from a client device 1108/1110 and determine if the payment server has authority to reset the payment card password for the first payment card;

Card validation unit 1502: configured to determine the validity of card information corresponding to one or more alternate payment cards received from a device 1108/1110;

Card binding/unbinding unit 1503: configured to optionally associate or dissociate a payment card from the first user account;

Alias password management unit 1505: configured to prompt creation and storage of, for example in database 1314, one or more alias passwords associated with one or more payment cards and user accounts.

Communications unit 1504 is configured to send and receive communications (e.g., server 1312 to and from client device 1308/1310 or server 1312 to and from financial institution server 1315).

It is acceptable to integrate the device shown in FIG. 15 into hardware entities of a variety of networks. For example, the realization device for identity authentication is allowed to be integrated into: server systems including mainframes, PC computers, portable electronic devices, commercial/enterprise servers etc.

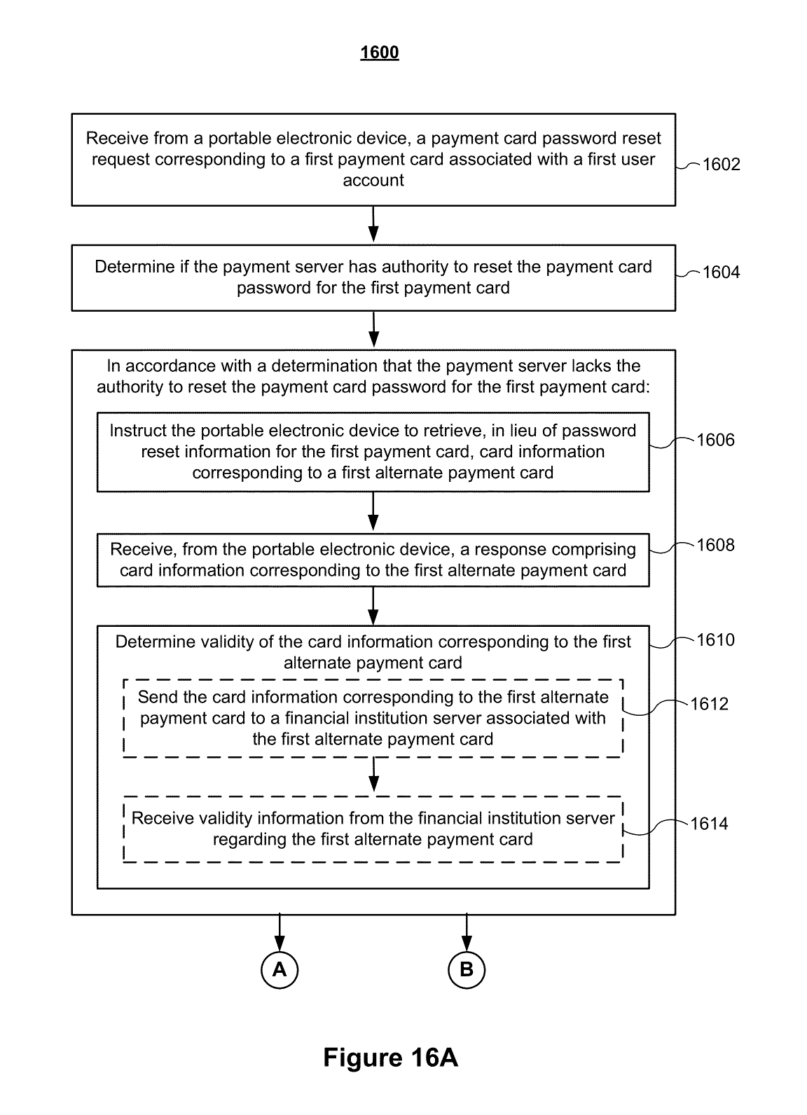

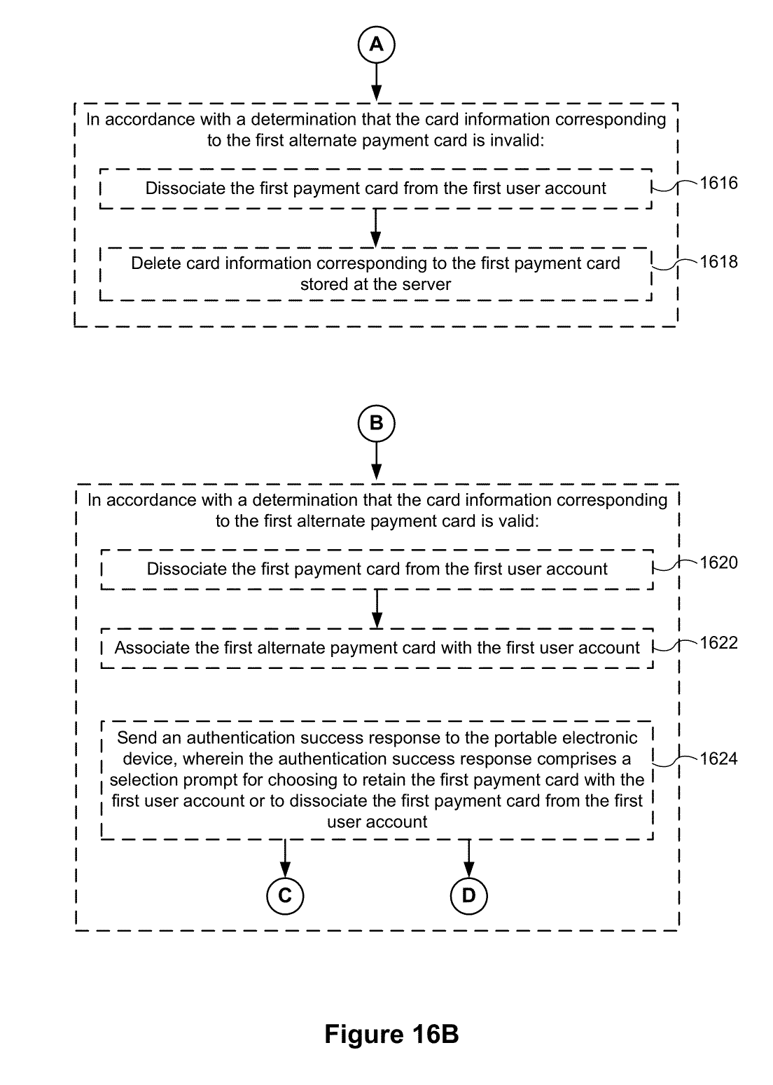

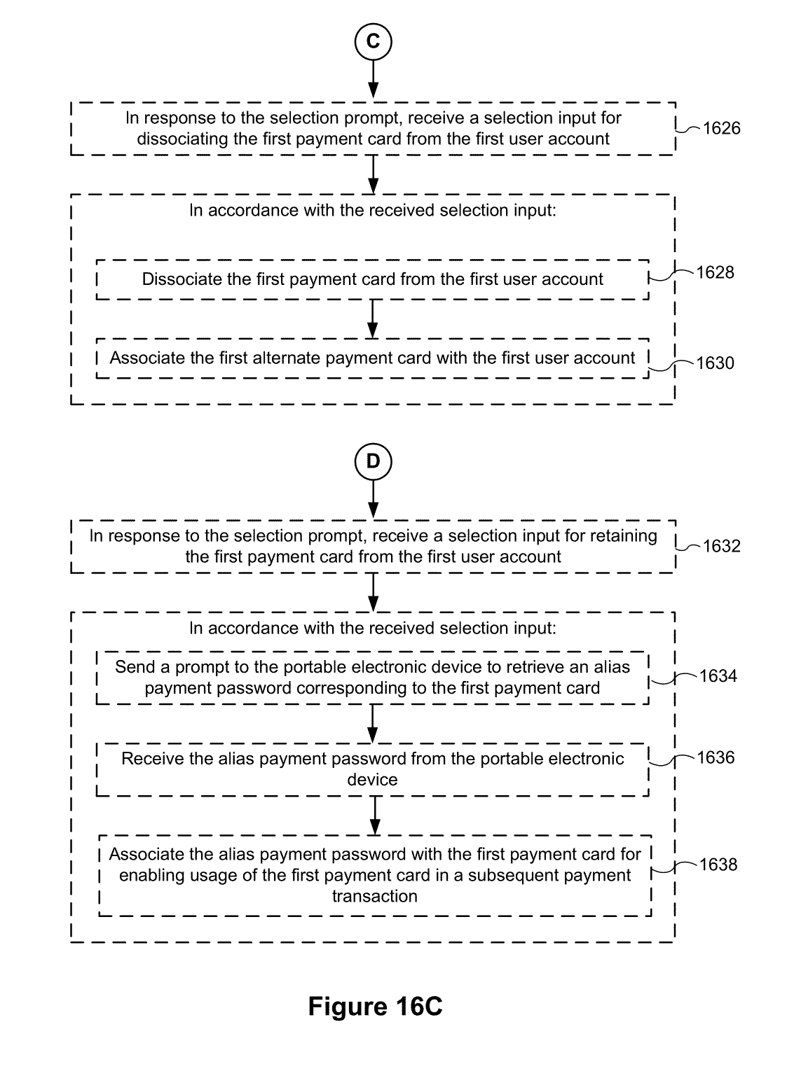

FIGS. 16A-16C are a flow chart of a method 1600 of resetting a payment password, at a payment server in accordance with some implementations of the present application. At a payment server having one or more processors, and memory for storing programs to be executed by the one or more processors, the method 1600 comprises receiving (1602), from a portable electronic device, a payment card password reset request corresponding to a first payment card associated with a first user account.

The method includes, determining (1604) if the payment server has authority to reset the payment card password for the first payment card. For example, in some circumstances, a payment server (e.g., server for an online store) receives a user-based or computer-generated request to reset the PIN, password, security question response or another security measure associated with a payment card (e.g., a credit card, debit card, pre-paid gift card). The method includes, in accordance with a determination that the payment server lacks the authority to reset the payment card password for the first payment card, instructing (1606) the portable electronic device to retrieve (e.g., by user input or computer-generated retrieval from memory), in lieu of password reset information for the first payment card, card information corresponding to a first alternate payment card. Examples of card information include card number, name on card, issuing institution, billing address and PIN, password or information associated with another security measure. In some embodiments, instead of information of a first alternate payment card, the server retrieves card information of a card that is not a payment card but provides identity information of the user (e.g., passport, government ID, student ID), and the sever performs the identity verification based on the retrieved information of that card.

In some embodiments, the method includes, receiving (1608), from the portable electronic device, a response comprising card information corresponding to the first alternate payment card. The method includes, determining (1610) validity of the card information corresponding to the first alternate payment card. In some embodiments, determining (1610) the validity of the received card information corresponding to the first alternate payment card comprises sending (1612) the card information corresponding to the first alternate payment card to a financial institution server associated with the first alternate payment card and receiving (1614) validity information from the financial institution server regarding the first alternate payment card.

In some embodiments, the method includes, in accordance with a determination that the card information corresponding to the first alternate payment card is invalid, dissociating (1616) the first payment card from the first user account and deleting (1618) card information corresponding to the first payment card stored at the server.

In some embodiments, the method includes, in accordance with a determination that the card information corresponding to the first alternate payment card is valid, dissociating (1620) the first payment card from the first user account and associating (1622) the first alternate payment card with the first user account. In some embodiments, the method includes, in accordance with a determination that the card information corresponding to the first alternate payment card is valid, sending (1624) an authentication success response to the portable electronic device, wherein the authentication success response comprises a selection prompt for choosing to retain the first payment card with the first user account or to dissociate the first payment card from the first user account.

In some embodiments, the method further includes, in response to the selection prompt, receiving (1626) a selection input (from the portable electronic device) for dissociating the first payment card from the first user account. In some embodiments, the method includes, in accordance with the received selection input, dissociating (1628) the first payment card from the first user account and associating (1630) the first alternate payment card with the first user account.

In some embodiments, the method further includes, in response to the selection prompt, receiving (1632) a selection input for retaining the first payment card with the first user account. In some embodiments, the method further includes, in accordance with the received selection input, sending (1634) a prompt to the portable electronic device to retrieve (e.g., through user input, or computer-generated retrieval from memory) an alias payment password corresponding to the first payment card. In some embodiments, the alias payment password is a password corresponding to the first payment card, and exclusively the payment server (i.e., no other payment or financial institution server), allowing the first payment card to be used at another payment/financial institution with the original payment card password. In some embodiments, the method includes receiving (1636) the alias payment password from the portable electronic device and associating (1638) the alias payment password with the first payment card for enabling usage of the first payment card in a subsequent payment transaction. In some embodiments, the payment server (e.g., payment server 1312) retains the original payment card password (i.e., the one forgotten by the user), and transmits that password to the financial institution server (e.g., server system 1315) to perform a payment transaction, but accepts receipt of the alias password in lieu of the original payment card password associated with the first payment card and the first user account for security authorization.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

What is claimed is:

1. A method of resetting a payment password, comprising:
at a payment server having one or more processors, and memory for storing programs to be executed by the one or more processors:
receiving, from a portable electronic device, a payment card password reset request corresponding to a first payment card associated with a first user account;
determining if the payment server has authority to reset the payment card password for the first payment card; and
in accordance with a determination that the payment server lacks the authority to reset the payment card password for the first payment card:
instructing the portable electronic device to retrieve, in lieu of password reset information for the first payment card, card information corresponding to a first alternate payment card;
receiving, from the portable electronic device, a response comprising card information corresponding to the first alternate payment card; and
determining validity of the card information corresponding to the first alternate payment card.

2. The method of claim 1, further comprising:
in accordance with a determination that the card information corresponding to the first alternate payment card is valid:
dissociating the first payment card from the first user account; and
associating the first alternate payment card with the first user account.

3. The method of claim 1, further comprising:
in accordance with a determination that the card information corresponding to the first alternate payment card is valid:
sending an authentication success response to the portable electronic device, wherein the authentication success response comprises a selection prompt for choosing to retain the first payment card with the first user account or to dissociate the first payment card from the first user account.

4. The method of claim 3, further comprising:
in response to the selection prompt, receiving a selection input for dissociating the first payment card from the first user account; and
in accordance with the received selection input:
dissociating the first payment card from the first user account; and
associating the first alternate payment card with the first user account.

5. The method of claim 3, further comprising:
in response to the selection prompt, receiving a selection input for retaining the first payment card with the first user account; and
in accordance with the received selection input:
sending a prompt to the portable electronic device to retrieve an alias payment password corresponding to the first payment card;
receiving the alias payment password from the portable electronic device; and
associating the alias payment password with the first payment card for enabling usage of the first payment card in a subsequent payment transaction.

6. The method of claim 1, further comprising:
in accordance with a determination that the card information corresponding to the first alternate payment card is invalid:
dissociating the first payment card from the first user account; and
deleting card information corresponding to the first payment card stored at the server.

7. The method of claim 1, wherein determining the validity of the received card information corresponding to the first alternate payment card comprises:
sending the card information corresponding to the first alternate payment card to a financial institution server associated with the first alternate payment card; and
receiving validity information from the financial institution server regarding the first alternate payment card.

8. A server, comprising:
one or more processors;
memory having instructions stored thereon, the instructions, when executed by the one or more processors, cause the processors to perform operations comprising:
receiving, from a portable electronic device, a payment card password reset request corresponding to a first payment card associated with a first user account;
determining if the payment server has authority to reset the payment card password for the first payment card; and
in accordance with a determination that the payment server lacks the authority to reset the payment card password for the first payment card:
instructing the portable electronic device to retrieve, in lieu of password reset information for the first payment card, card information corresponding to a first alternate payment card;
receiving, from the portable electronic device, a response comprising card information corresponding to the first alternate payment card; and
determining validity of the card information corresponding to the first alternate payment card.

9. The server of claim 8, wherein the operations further comprise:
in accordance with a determination that the card information corresponding to the first alternate payment card is valid:
dissociating the first payment card from the first user account; and
associating the first alternate payment card with the first user account.

10. The server of claim 8, wherein the operations further comprise:
in accordance with a determination that the card information corresponding to the first alternate payment card is valid:
sending an authentication success response to the portable electronic device, wherein the authentication success response comprises a selection prompt for choosing to retain the first payment card with the first user account or to dissociate the first payment card from the first user account.

11. The server of claim 10, wherein the operations further comprise:
in response to the selection prompt, receiving a selection input for dissociating the first payment card from the first user account; and
in accordance with the received selection input:
dissociating the first payment card from the first user account; and
associating the first alternate payment card with the first user account.

12. The server of claim 10, wherein the operations further comprise:
in response to the selection prompt, receiving a selection input for retaining the first payment card with the first user account; and
in accordance with the received selection input:
sending a prompt to the portable electronic device to retrieve an alias payment password corresponding to the first payment card;
receiving the alias payment password from the portable electronic device; and
associating the alias payment password with the first payment card for enabling usage of the first payment card in a subsequent payment transaction.

13. The server of claim 8, wherein the operations further comprise:
in accordance with a determination that the card information corresponding to the first alternate payment card is invalid:
dissociating the first payment card from the first user account; and
deleting card information corresponding to the first payment card stored at the server.

14. The server of claim 8, wherein determining the validity of the received card information corresponding to the first alternate payment card comprises:
sending the card information corresponding to the first alternate payment card to a financial institution server associated with the first alternate payment card; and
receiving validity information from the financial institution server regarding the first alternate payment card.

15. A non-transitory computer readable storage medium storing one or more programs, the one or more programs comprising instructions, which when executed by a server, cause the server to:
receive, from a portable electronic device, a payment card password reset request corresponding to a first payment card associated with a first user account;
determine if the payment server has authority to reset the payment card password for the first payment card;
in accordance with a determination that the payment server lacks the authority to reset the payment card password for the first payment card:
instruct the portable electronic device to retrieve, in lieu of password reset information for the first payment card, card information corresponding to a first alternate payment card;
receive, from the portable electronic device, a response comprising card information corresponding to the first alternate payment card; and
determine validity of the card information corresponding to the first alternate payment card.

16. The non-transitory computer readable storage medium of claim 15, further comprising instructions that cause the device to:
in accordance with a determination that the card information corresponding to the first alternate payment card is valid:
dissociate the first payment card from the first user account; and
associate the first alternate payment card with the first user account.

17. The non-transitory computer readable storage medium of claim 15, further comprising instructions that cause the device to:
in accordance with a determination that the card information corresponding to the first alternate payment card is valid:
send an authentication success response to the portable electronic device, wherein the authentication success response comprises a selection prompt for choosing to retain the first payment card with the first user account or to dissociate the first payment card from the first user account.

18. The non-transitory computer readable storage medium of claim 17, further comprising instructions that cause the device to:
in response to the selection prompt, receive a selection input for dissociating the first payment card from the first user account; and
in accordance with the received selection input:
dissociate the first payment card from the first user account; and
associate the first alternate payment card with the first user account.

19. The non-transitory computer readable storage medium of claim 17, further comprising instructions that cause the device to:
in response to the selection prompt, receive a selection input for retaining the first payment card with the first user account; and
in accordance with the received selection input:
send a prompt to the portable electronic device to retrieve an alias payment password corresponding to the first payment card;
receive the alias payment password from the portable electronic device; and
associate the alias payment password with the first payment card for enabling usage of the first payment card in a subsequent payment transaction.

20. The non-transitory computer readable storage medium of claim 15, further comprising instructions that cause the device to:
in accordance with a determination that the card information corresponding to the first alternate payment card is invalid:
dissociate the first payment card from the first user account; and
delete card information corresponding to the first payment card stored at the server.
